(19) United States
(12) Patent Application Publication
(10) Pub. No.: US 2001/0045001 A1
(43) Pub. Date: Nov. 29, 2001

(54) End cap insertion device for capping tubes and tubular containers

(76) Inventor: Michael William Hunter, Bedford, NH (US)

Correspondence Address: MAINE & ASMUS, 100 MAIN STREET, P O BOX 3445, NASHUA, NH, 03061-3445, US

(21) Appl. No.: 09/768,798

(22) Filed: Jan. 24, 2001

Related U.S. Application Data
(60) Provisional application No. 60/182,889, filed on Feb. 14, 2000.

(51) Int. Cl. B23P 11/02; B23P 19/00

(52) U.S. Cl. 29/525; 29/700; 29/252; 29/771

(57) ABSTRACT

An end cap is supported by a retractable holding mechanism between an edge press and tube end. A pick up mandrel and extender are mounted in the edge press head. The pick up mandrel is extendible from the edge press to contact the end cap. Non-mechanical means on the pick up mandrel secure the cap to the pick up mandrel while the holding mechanism is retracted. The pick up mandrel carries the end cap to the tube end. The extender is collapsed under pressure of the edge press, allowing it to contact the skirt of the cap and press it into the tube end. The pickup mandrel is retracted into the edge press head, releasing its grip on the end cap, and the edge press head and pickup mandrel are retracted for another cycle.

### CROSS REFERENCE TO RELATED APPLICATIONS

This application relates and claims priority for all purposes to pending U.S. patent application Ser. No. 60/182,889, filed Feb. 14, 2000, by the same applicant.

### BACKGROUND OF THE INVENTION

1. Technical Field of the Invention

This invention relates to an interference press fit capping operation for tubular metal containers using metal caps, and in particular to a novel and useful means by which an end cap can be manipulated and applied to the open tube end in an interference press fit using a double action mandrel assembly to pick up and insert the cap.

2. Background Art

The art of assembly of cylindrical devices, including the application of end caps of all types, is old and broad. There are undoubtedly many ways to cap an opened tube or cylindrical container such as in the manufacturing of conventional, hand operated fire extinguishers which are generally configured as a pressurized cylinder with a closed bottom end and a nozzle of some sort attached to the top end.

Among the general methods widely practiced for capping a tube or cylindrical container is the “interference fit”, where the end cap has a wall height sufficient to prevent tipping of the end cap within the tube, and the diameter of the end cap is carefully calculated to be slightly too large for a slip fit into the tube, but can be inserted into the tube end by using careful alignment and considerable pressure, typically with a press of some sort. In this general manner, one may force the end cap into the tube in a compressive, permanent fit that may not require any additional fasteners or bonding agents, depending on the actual materials and the application.

An interference fit capping operation can be conducted manually, however it is the production requirement to which more sophisticated efforts have been directed. There is recent exemplary patent art. Aronne's U.S. Pat. No. 5,671,522, published Sep. 30, 1997, for a method and apparatus for sealing a pressure vessel, illustrates a cylinder closed by means of a pair of specially constructed end caps each having annular recesses formed around their circumference. The ends of the cylinders are engaged within the recess and joined by magnetic pulse forming. The magnetic pulse foxing force is asserted radially inward against a mandrel which mates with a depression formed in the caps so that the assembled cylinder and cap are squeezed into a sealed relationship.

Moran et al's U.S. Pat. No. 5,839,869, published Nov. 24, 1998, for a seaming apparatus, discloses an apparatus for seaming a cap to an open end of a container body. The apparatus includes a lifter pad to support the container body, a seaming chuck to support the cap in place on the container body, and an annular seaming tool having seaming profiles on its inner surface which surrounds the cap. There is a drive means for providing relative rolling movement between the seaming tool and the cap. Rotation of the seaming tool configured with sequential seaming profiles provides the seal.

Richards et al's U.S. Pat. No. 4,295,838, published Oct. 20, 1981, teaches a method of producing cylindrical containers where a container manufacturing apparatus forms a generally tubular container on a mandrel with an end member being sealed to the container side wall to form an open topped container. The conveyor grips the open topped container for various top end operations that will enable capping after filling.

While every production situation has its own unique requirements, there are common elements to be addressed. There must be a supply of end caps and a supply of open ended containers or tubes, and suitable machinery to advance the blanks through the capping station. Details begin to diverge widely according to the size, material, thickness, and type of seal desired. While many methods and machines have been devised to perform the general function, clever and inventive improvements in machine design that offer rugged simplicity and operational reliability are always appreciated.

The instant disclosure relates to an interference press fit capping operation for tubular metal containers and metal caps, and in particular addresses the manner in which an end cap can be manipulated for application to the open end of a tubular container as an interference press fit.

### SUMMARY OF THE INVENTION

It is an object of the invention to provide a double action mandrel assembly for the pick up and insertion of a circular end cap as an interference press fit in the open end of a tubular container.

It is a further object of the invention to grip the end cap and secure it to the face of a pick up mandrel for manipulation, in a non-mechanical fashion that assures there will be no unnecessary moving structure that will contribute to possible mechanical interferences with the mandrel motion, or failures with the gripping and release mechanism.

It is a yet further object of the invention to have a retractable holding station that will receive an end cap from a supply of end caps and hold it suspended edgewise in a holding position proximate an open tube end where it may be readily gripped for the capping operation, and the holding station structure then be laterally retractable so as to be out of the way of the actual capping operation.

It is a still yet further objective to have a pick up mandrel within an edge press mandrel mounted on a capping press, where an actuator operates the pickup mandrel for extension and retraction relative to the edge press mandrel, and the edge press mandrel is operated by the press.

It is another object of the invention to provide a non-mechanical means for holding an end cap on the face of the pick up mandrel so that it can be advanced to and inserted into an open tube end, and where the non-mechanical means can be overcome to separate the end cap from the pick up mandrel when the pickup mandrel is retracted from the capped tube.

It is still another object of the invention to provide a device suitable for incorporation into a production process for capping tubular metal containers with metal end caps using an interference press fit.

Still other objects and advantages of the present invention will become readily apparent to those skilled in this art from the following detailed description, wherein I have shown and described only a preferred embodiment of the invention, simply by way of illustration of the best mode contemplated by me on carrying out my invention. As will be realized, the invention is capable of other and different embodiments, and its several details are capable of modifications in various obvious respects, all without departing from the invention.

### BRIEF DESCRIPTION OF THE DRAWINGS

FIG. 1 is a limited diagrammatic plan view of an end cap in the edgewise holding position, closely confined between opposing channel guides and resting against a stop.

FIG. 2 is a cross section view of a preferred embodiment of the invention, illustrating an end cap suspended between opposing channel guides as in FIG. 1, between a tube end and a double action mandrel assembly.

FIG. 3 is a next sequential cross section view of FIG. 2, with the pick up mandrel having been extended from the edge press mandrel into contact with the back side or outside of the center section of the end cap, the channel guides having not yet been removed.

FIG. 4 is a next sequential cross section view of FIG. 3, with the channel guides having been retracted laterally away from the end cap and out of the range of travel of the edge press mandrel, leaving the end cap magnetically attached to the face of the pick up mandrel.

FIG. 5 is a next sequential cross section view of FIG. 4, with the edge press mandrel having been extended forward between the channel guides until the leading edge shoulder of the end cap contacts the tube end.

FIG. 6 is a next sequential cross section view of FIG. 5, with the edge press mandrel having collapsed the pick up mandrel actuator and closed over the pick up mandrel until the shoulder of the edge press mandrel contacts the edge of the end cap skirt.

FIG. 7 is a next sequential cross section view of FIG. 6, with the edge press mandrel having advanced so as to fully insert the end cap into the tube end.

FIG. 8 is a next sequential cross section view of FIG. 7, with the pick up mandrel having been retracted by its actuator so as to break the magnetic grip on the end cap and be returned to its starting position with respect to the edge press mandrel.

### DESCRIPTION OF THE PREFERRED EMBODIMENT

The invention is susceptible of many embodiments. A preferred embodiment is described below and illustrated in the attached figures.

In the production line assembly of canisters for fire extinguishers, there is a device at a particular station which uses magnets, guides and a hydraulic powered mandrel to repetitively insert bottom closures or end caps into sequentially presented tubular bodies into a permanent pressure fit. These metal canisters will eventually be filled with fire retardant materials under pressure, and be expected to have a long shelf life, under pressure, in a public setting, without leakage and without undue risk of rupture, so the tolerances of the tube and end cap diameters are closely controlled to assure the interference fit, when completed, forms a good bond. The center section of these end caps are preformed to have a slightly rounded out or bowl shape, with a uniform radius, to better withstand the internal pressure of the fire extinguisher after assembly. The convex center section extends outward from the canister, after assembly.

The edge or perimeter of the center section of the end cap is formed with a short, tubular skirt of uniform diameter, the outer surface of which will be the area of contact for the tube wall when the end cap is pressed into place. The radius of the rolled edge transition from the center section to the skirt provides a rounded leading edge shoulder to the end cap that facilitates easy alignment or centering of the end cap with the open end of the tube when the two parts are brought into contact.

The operation, generally described, provides that the end cap is picked up from a delivery system and inserted into the open end of the tube under significant hydraulic pressure to form a permanent press fit that will withstand the working pressures of the end use product with an adequate safety margin. The capping station, or portion of the production machinery within which the invention resides, will likely be partially or fully integrated into the full production line system. The invention resides in the apparatus and manner in which the operation is performed.

There is a delivery system such as a walking beam, an assembly line or a robot, moving inverted, tubular canisters or similar objects, with open bottom ends up, one at a time into the station and out again after the end cap has been applied. There is a gravity feed supply tray that rolls down edgewise, one end cap at a time, into the same position and with the same orientation, for the insertion operation. The supply tray could be any automated delivery system that presents bottom closures, one at a time, at the same place with the same orientation with respect to the work station, for use in the automated capping operation.

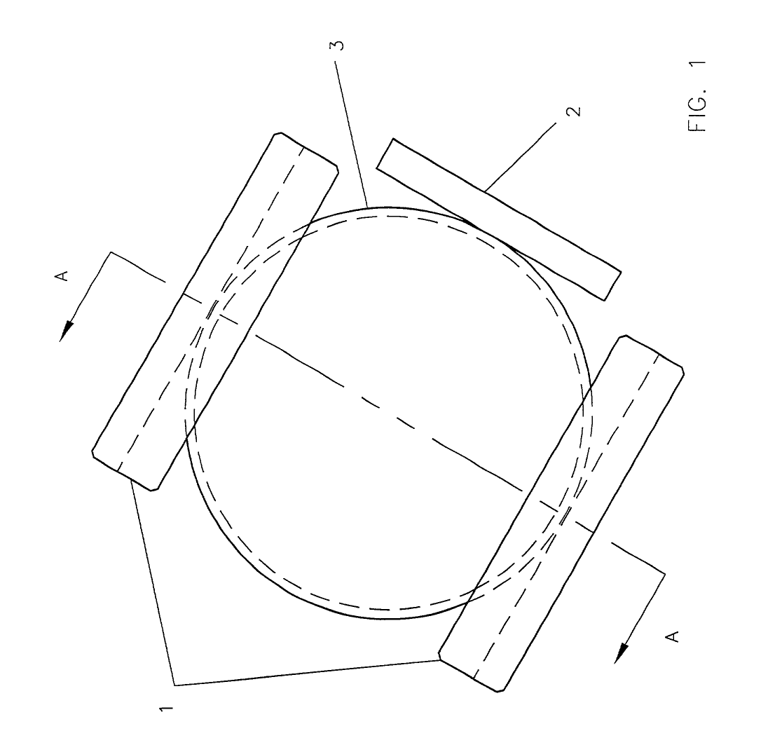

Referring now to FIG. 1, the receiving point for the end caps is configured with two opposing U shaped channel guides 1 aligned with the sloping feed tray, into which one end cap 3 at a time is permitted to roll on edge. A mechanical stop 2 limits the forward motion and positions the end cap consistently within the channel guides for the next step. The end cap is held on edge in this position, co-axial to and a short distance away from the open end of the tube that is next to be capped. The distal end of the horizontally oriented tube is properly supported to withstand the pressure of the capping operation that will follow.

A horizontally oriented hydraulic press is mounted co-axial to the tube capping position, with the end cap holding point interposed there in between. The range of motion of the press is sufficient to perform the operation described below.

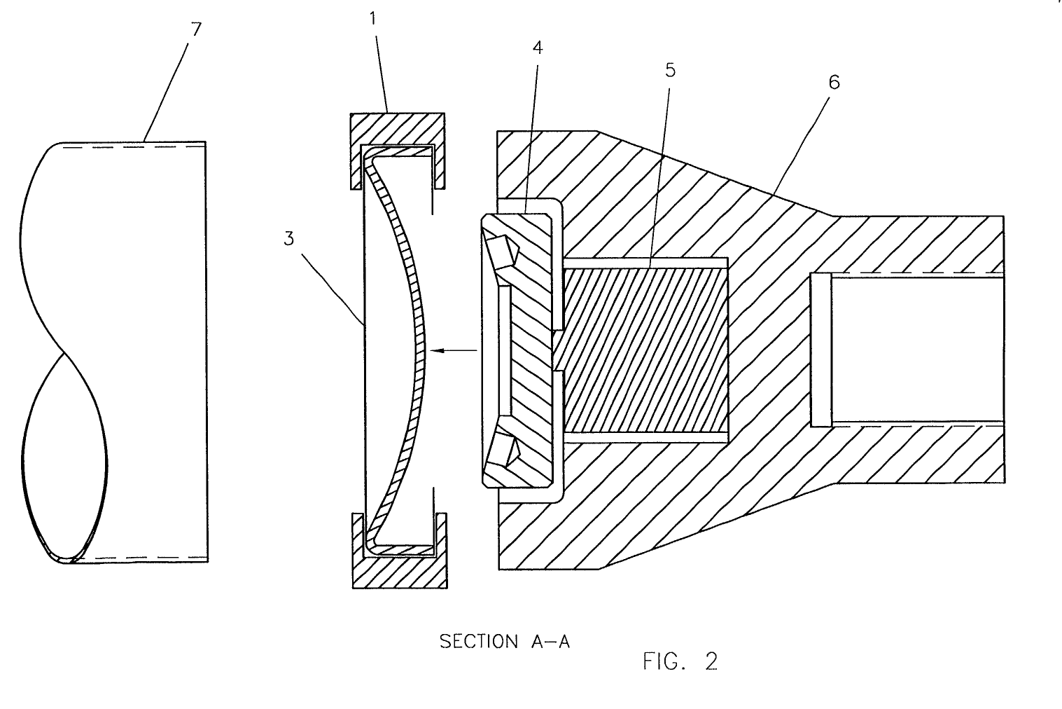

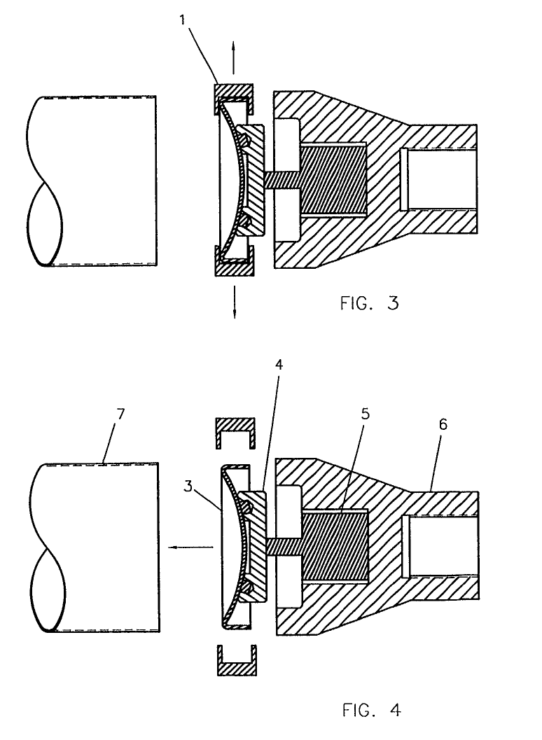

Referring now to FIG. 2, pickup mandrel 4 made of non-ferrous metal, mounted on hydraulic edge press 6 so as to be independently axially extendible over a short range by air cylinder 5, is extended out from the edge press head by air cylinder 5 into contact with the convex, outside surface of end cap 3. The face of mandrel 4 has been machined to roughly match the convex surface of the end cap. Small permanent magnets 4A have been securely embedded in the face of mandrel 4. These magnets attract and secure the end cap to the face of the mandrel while channel guides 1 and stop 2 are moved laterally away from the end cap and out of the path of the press, as indicated in FIGS. 3 and 4.

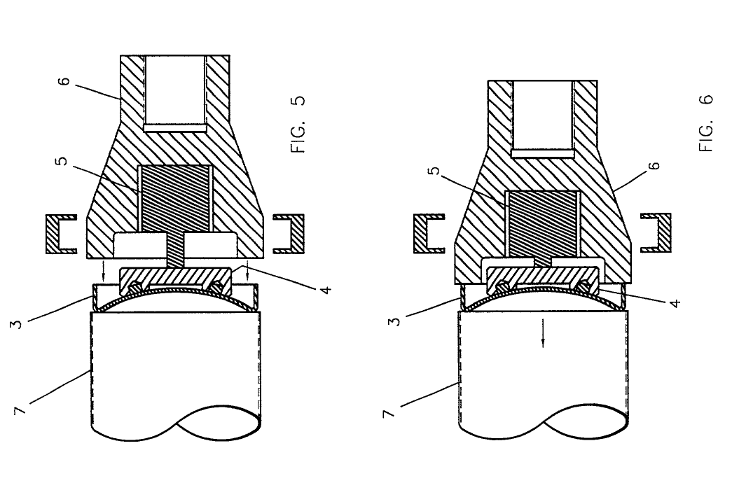

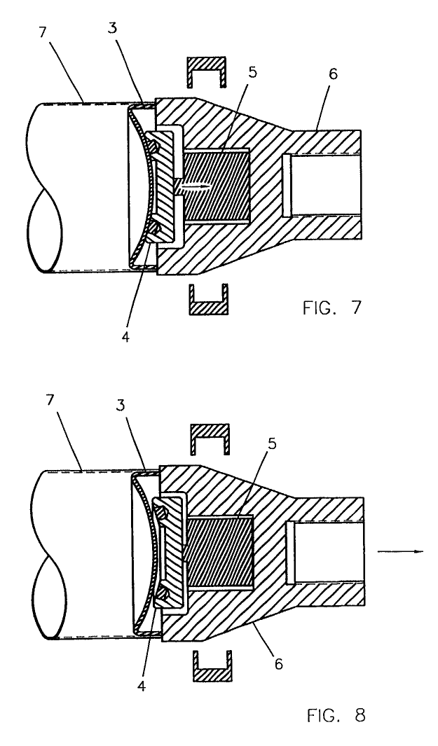

The hydraulic press is then actuated to move the edge press head 6, and air cylinder 5 5 and mandrel 4 assembly, together with end cap 3 magnetically held in position on the mandrel face, towards the open end of tube 7, as indicated in FIGS. 4 and 5. The rounded leading edge shoulder of end cap 3 serves to provide a self-aligning aspect to the initial seating of the end cap on the tube end. Being an interference fit, end cap 3 does not slide readily into tube 7. Instead, the air pressure in air cylinder 5 is overcome by the greater lo hydraulic pressure behind the edge press 6, and air cylinder 5 begins to collapse until edge press 6 contacts the back edge of the skirt of end cap 3, the hydraulic pressure then directly forcing edge press 6 forward and end cap 3 into tube 7, until the shoulder of press head 6 contacts the edge of tube 7, as indicated in FIGS. 5-7.

The air pressure is then relieved and air cylinder 5 is retracted so as to break the magnetic grip of mandrel 4 on end cap 3 and retract the mandrel into edge press 6. The hydraulic press is likewise retracted, repositioning mandrel 4, air cylinder 5, and edge press 6 for the next cycle. The capped tube is moved out by the delivery system and a new tube advanced into its position. Channel guides 2 and stop 3 are moved back into starting position and a new end cap 3 is advanced into its position for the next cycle, all as illustrated in FIGS. 8, 1 and 2.

Fundamental aspects of the invention include the elements and the sequence of the double acting action of pick up mandrel 4, and edge press 6, with an actuator interposed there in between to provide the initial mandrel motion into contact with the next end cap which is being held in position by retractable holding structure here consisting of channel guides 1 and mechanical stop 2, a non-mechanical means of attachment of the end cap to the pick up mandrel and subsequent retracting of the end cap holding structure to provide clearance for transport of the end cap on pick up mandrel 4 and edge press 6 to the tube end, the collapse of the intermediate actuator, here air cylinder 5, and direct contact with and insertion of the end cap by face of edge press 6 into the open tube end, and the breaking of the non-mechanical bond with the end cap as the mandrel is withdrawn by the retracting the edge press.

To those skilled in the art, the invention admits of many variations. For example, there is a double action assembly and machine for inserting with an interference fit an end cap with a folded back skirt of uniform diameter into an open end of a tubular structure, that has means for supporting a tubular structure so as to withstand co-axially applied insertion pressure. The end cap and the tube end of the structure may be of round, oval, square or rectangular or other regular or irregular shape, so long as the end cap is engineered for a press fit into the tube end. This embodiment uses a press with an edge press mandrel or head for applying the insertion pressure, where the edge press mandrel is of larger diameter than the skirt of the end cap, the press configured with its axis aligned with the axis of the support structure for the tube. The edge press mandrel or head is movable between retracted and extended positions relative to the press. There is a laterally retractable support structure for receiving and holding an end cap in a holding position coaxial to and in between the edge press and the tube end. There is a pick up mandrel with an extension actuator coaxially mounted within the face of the edge press, the pick up mandrel being of smaller diameter than the skirt of the end cap so that it can reach into the skirt to the center section of the end cap.

The pick up mandrel is extendible coaxially outward from the edge press mandrel into contact with the center section of the end cap. The face of the pick up mandrel conforms substantially to the surface shape of the end cap so that a non-mechanical bonding feature on the face of pick up mandrel can grip and secure the end cap without introducing misalignment. The skirt of the end cap when properly secured, is concentric with the edge press mandrel. The extension actuator is collapsible under insertion pressure so as to permit the edge press mandrel to contact the skirt. The end cap is thus insertable under pressure from the edge press mandrel into the open end of the tubular structure. The pickup mandrel is retractable into the edge press mandrel with sufficient force to overcome the non-mechanical means for securing the end cap, after it has been installed in the tube end. The edge press mandrel is then retractable towards the press to its starting position. Thus, the machine can be referred to as a double action mandrel press.

As a variation of the invention, there is a machine as in the above example for inserting with an interference fit an end cap on a tube end, used in combination with a system for production assembly of end caps into the open ends of said tubular structures.

As another variation of the invention, there is a machine for inserting with an interference fit an end cap as in the above example where the non-mechanical means is one or more magnets recessed with the face of the pick up mandrel. The magnets may be permanent or be operated by electrical coils so as to be strong enough to grip the end caps when they are made of materials having enough magnetic attractive so that the magnets can hold the weight of the end cap.

As yet another variation of the invention, there is a machine as in the example above, where the tubular structure is intended to be completed as a fire extinguisher, and the open end is the bottom end thereof. None the less, it will be readily apparent that there are limitless possible articles of manufacture that may incorporate or have tubular structures with open tube ends which might be capped in accordance with the methods and devices of the invention, whether in the course of manufacturing or in the use of the article.

Still yet another variation is a machine as in the example above, where the press, which might be referred to as the major actuator in the system which drives the edge press mandrel, is hydraulic, and the extendible actuator which drives the pick up mandrel and might be referred to as the minor actuator in the system, is an air cylinder. Actuators of all types may be mixed and matched to provide a suitable major/minor actuator relationship, such that the major actuator can apply full insertion pressure to the edge press mandrel sufficient to collapse the minor actuator that powers the pick up mandrel, and push on to insert the end cap with an interference fit. The minor actuator has only to carry the end cap forward to the tube end, and upon retraction, to break the non-mechanical bond between the pick up mandrel face and the end cap.

As another example of the method and apparatus of the invention, there is a production line system for installing circular end caps on tubular articles, consisting of the necessary machinery for receiving and supporting a next tubular article from a supply of tubular articles, a device for receiving an end cap from a supply of end caps where the end caps have a convex center section with a front edge radius and cylindrical, folded back skirt of uniform diameter, the skirt being sized for an interference fit within the open end of the tubular article. The device is configured for edge supporting the end cap coaxially and proximate the open end of the tubular article.

There is a non-mechanical feature associated with a pick up mandrel, for gripping the end cap by the outside of the center section. The pick up mandrel is mounted with its own extending actuator coaxially within the face of an edge press mandrel mounted in a press, where the press and the edge press mandrel are coaxially aligned with said tubular article. The extension actuator may be a one-way air cylinder with a spring bias return, or a two-way air cylinder, or any other type or combination of linear actuators that can be controlled to produce the necessary force vectors, and yet be uniformly and smoothly collapsed by the press or primary system actuator when the interference fit pressure is applied.

The pick up mandrel with its gripping feature is movable by operation of its actuator from a retracted position in the edge press mandrel to a coaxially extended position so as to contact the center section of the end cap with the gripping feature. The grip on the end cap may be effected by magnetic, electromagnetic, adhesive, or suction-based techniques, or by other non-mechanical means of attachment, so that there is little or no probability of mechanical mal-adjustment or interference in this aspect of the capping operation.

The structure for edge supporting an end cap in the holding position is further adapted for being laterally retractable or removable away from the end cap and out of the way of the edge press mandrel, after the end cap is picked up by the pick up mandrel. The edge support structure is moved back into place each cycle for receiving and holding the next end cap for pick up. The system is further equipped, such as with assembly line or robotic machinery, to rotate out the capped tube and advance another open ended tube into position for capping. Computers, power sources and other features common to automated production machinery are likely to be incorporated to a greater or lesser extent. Control/display units and necessary operator interfaces will likewise be associated with the system.

One method within the scope of the invention for inserting with an interference fit an end cap with a folded back skirt of uniform diameter into an open end of a tubular structure, consists of the steps of supporting a tubular structure so as to withstand co-axially applied insertion pressure, supporting an end cap with a retractable holding structure in a holding position coaxial to and interspersed between the press and the open end of the tubular structure, coaxially extending a pick up mandrel into contact with the end cap by means of an extension actuator mounted within an edge press mandrel that is in turn mounted in a press, where the pickup mandrel is of smaller diameter than the skirt and the face of the pick up mandrel conforms substantially to the surface shape of the end cap, and retracting the retractable holding structure so as to provide clearance between the edge press mandrel and the open end of the tubular structure.

Further steps of this methodology include securing the end cap to the face of the pick up mandrel by non-mechanical means where the tubular skirt of the end cap when secured thereto is concentric with the edge press mandrel, extending the edge press mandrel from the press so as to move the end cap from the holding position into contact with the open end of the tubular structure, collapsing the extension actuator under insertion pressure so as to bring the edge press mandrel into contact with the skirt of the end cap, inserting the end cap into the open end of the tubular structure under insertion pressure as applied by the edge press mandrel, releasing the non-mechanical means and retracting the pickup mandrel into the edge press mandrel, and then retracting said edge press mandrel towards said press.

In summary, the invention provides methods and apparatus, particularly adaptable to production situations, for applying a circular cap to an open tube end with an interference fit, where the system incorporates a two step extension process to pick up the end cap and apply it to the tube end. It further employs a non-mechanical means for attaching the end cap to the pick up mandrel, and a collapsible means of actuating the pickup mandrel, so that the edge press mandrel can make contact and provide the primary insertion force directly against the rim or skirt of the end cap.

The objects and advantages of the invention may be further realized and attained by means of the instrumentalities and combinations particularly pointed out in the appended claims. Accordingly, the drawings and description are to be regarded as illustrative in nature, and not as restrictive.

I claim:

1. A machine for inserting with an interference fit an end cap with a folded back skirt of uniform diameter into an open end of a tubular structure, comprising
means for supporting a said tubular structure so as to withstand co-axially applied insertion pressure,
a press with an edge press mandrel for applying said insertion pressure, said edge press mandrel being of larger diameter than said end cap, said press being concentric with said means for supporting said tubular structure, said edge press mandrel being movable between retracted and extended positions relative to said press,
laterally retractable means for supporting a said end cap in a holding position coaxial to and interspersed between said press and said open end of said tubular structure,
a pick up mandrel and extension actuator coaxially mounted within said edge press mandrel, said pickup mandrel being of smaller diameter than said skirt of said end cap, said pick up mandrel being extendible coaxially outward from said edge press mandrel into contact with said end cap, the face of said pick up mandrel conforming substantially to the surface shape of said end cap,
non-mechanical means on said face of said pick up mandrel for securing a said end cap thereto, said tubular skirt of said end cap when secured thereto being concentric with said edge press mandrel, said extension actuator being collapsible under said insertion pressure so as to permit said edge press mandrel to contact said skirt, said end cap thus being insertable under said insertion pressure by said edge press mandrel into said open end of said tubular structure, said pickup mandrel being retractable into said edge press mandrel with sufficient force to overcome said non-mechanical means for securing said end cap.

2. A machine for inserting with an interference fit an end cap according to claim 1, in combination with a system for production assembly of said end caps into the open ends of said tubular structures.

3. A machine for inserting with an interference fit an end cap according to claim 1, said non-mechanical means comprising magnets recessed with said face of said pick up mandrel, said end caps comprising at least some ferrous content.

4. A machine for inserting with an interference fit an end cap according to claim 1, said tubular structure being a fire extinguisher, said open end being a bottom end thereof.

5. A machine for inserting with an interference fit an end cap according to claim 1, said press being a hydraulic press, said actuator being an air cylinder.

6. A production line system for installing circular end caps on tubular articles, comprising
means for receiving and supporting a next said tubular article from a supply of said tubular articles,
means for receiving an end cap from a supply of said end caps, said end caps having a convex center section with a front edge radius and cylindrical skirt of uniform diameter, said skirt being sized for an interference fit within the open end of said tubular article,
means for edge supporting said end cap coaxially and proximate said open end of said tubular article,
non-mechanical means for gripping said end cap by the outside of said center section, said means for gripping being coaxially resident within an edge press mandrel, said edge press mandrel being coaxially aligned with said tubular article,
means for moving said means for gripping from a retracted position in said edge press mandrel to a coaxially extended position so as to contact said center section of said end cap with said means for gripping,
means for laterally removing said means for edge supporting away from said end cap,
means for advancing said edge press mandrel from a starting position towards said tubular article so as to transport a gripped said end cap into contact with said open end of said tubular article,
means for compressing said means for gripping said end cap so as to place said edge press mandrel into contact with said skirt,
means for advancing said edge press mandrel and said means for gripping so as to compressively insert said end cap into said open end of said tubular article,
means for moving said means for gripping into said retracted position in said edge press mandrel so as to separate said means for gripping from said end cap,
means for retracting said edge press mandrel away from said tubular article to said starting position,
means for removing the capped said tubular article for a next cycle.

7. A production line system for installing circular end caps on tubular articles according to claim 6, said end caps fabricated of materials having at least some ferrous content, said means for gripping being magnetic.

8. A production line system for installing circular end caps according to claim 6, said tubular structure being a fire extinguisher, said open end being a bottom end thereof.

9. A production line system for installing circular end caps according to claim 6, said press being a hydraulic press, said actuator being an air cylinder.

10. A method for inserting with an interference fit an end cap with a folded back skirt of uniform diameter into an open end of a tubular structure, comprising the steps of
supporting a said tubular structure so as to withstand co-axially applied insertion pressure,
supporting a said end cap with a retractable holding structure in a holding position coaxial to and interspersed between said press and said open end of said tubular structure,
coaxially extending a pick up mandrel into contact with said end cap by means of an extension actuator mounted within an edge press mandrel that is in turn mounted in a press, said pickup mandrel being of smaller diameter than said skirt, the face of said pick up mandrel conforming substantially to the surface shape of said end cap,
securing said end cap to said face of said pick up mandrel by non-mechanical means, said tubular skirt of said end cap when secured thereto being concentric with said edge press mandrel,
retracting said retractable holding structure so as to provide clearance between said edge press mandrel and said open end of a tubular structure,
extending said edge press mandrel from said press so as to move said end cap from said holding position into contact with said open end of said tubular structure,
collapsing said extension actuator under said insertion pressure so as to bring said is edge press mandrel into contact with said skirt of said end cap,
inserting said end cap into said open end of said tubular structure under said insertion pressure as applied by said edge press mandrel,
releasing said non-mechanical means and retracting said pickup mandrel into said edge press mandrel,
retracting said edge press mandrel towards said press.

11. A method for inserting with an interference fit an end cap according to claim 10, in combination with a system for production assembly of said end caps into the open ends of said tubular structures.

12. A method for inserting with an interference fit an end cap according to claim 10, said non-mechanical means comprising magnets recessed with said face of said pick up mandrel, said end caps comprising at least some ferrous content.

13. A method for inserting with an interference fit an end cap according to claim 10, said tubular structure being a fire extinguisher, said open end being a bottom end thereof.

14. A method for inserting with an interference fit an end cap according to claim 10, said press being a hydraulic press, said actuator being an air cylinder.
